(19) United States
(12) Patent Application Publication
(10) Pub. No.: US 2007/0242790 A1
(43) Pub. Date: Oct. 18, 2007

(54) 10B(d,n)11C REACTION BASED NEUTRON GENERATOR

(75) Inventors: Tak Pui Lou, Berkeley, CA (US); Ka-Ngo Leung, Hercules, CA (US)

Correspondence Address: LAWRENCE BERKELEY NATIONAL LABORATORY, ONE CYCLOTRON ROAD, MAIL STOP 90B, UNIVERSITY OF CALIFORNIA, BERKELEY, CA, 94720, US

(73) Assignee: The Regents of the University of California, Oakland, CA (US)

(21) Appl. No.: 11/694,538

(22) Filed: Mar. 30, 2007

Related U.S. Application Data
(60) Provisional application No. 60/787,887, filed on Mar. 30, 2006.

(51) Int. Cl. G21G 1/00

(52) U.S. Cl. 376/156

(57) ABSTRACT

A neutron generator comprising a boron-10 bearing target and a low-energy accelerator, wherein said low-energy accelerator emits a plurality of particles which bombard said boron-10 bearing target to cause a ¹⁰B(d,n)¹¹C reaction which in turn produces a plurality of neutrons having an energy value greater than about 2 MeV and less than about 8 MeV.

### CROSS-REFERENCE TO RELATED APPLICATIONS

This application claims priority to U.S. provisional patent application Ser. No. 60/787,887, filed Mar. 30, 2006; which is hereby incorporated by reference its entirety.

### STATEMENT OF GOVERNMENTAL SUPPORT

This invention was made with government support under Contract DE-AC02-05CH11231 awarded by the United States Department of Energy to The Regents of the University of California for the management and operation of the Lawrence Berkeley National Laboratory. The government has certain rights in this invention.

### FIELD OF THE INVENTION

The invention relates to neutron generators. More particularly, the invention relates to fast neutron generators based on low-energy accelerator. Even more particularly, the invention relates to neutron generators using the boron-10 fusion reaction.

### BACKGROUND OF THE INVENTION

One technique used to identify Special Nuclear Materials (SNM) is the so-called Nuclear Car Wash System, in which a cargo container is towed through a fast neutron source, high energy gamma source or high energy bremmsstrahlung X-ray source and monitored for any delayed gamma rays from either neutron- or photon- induced fission in illicit SNM hidden inside the container. It has been identified that the best neutron energy for a neutron-based Nuclear Car Wash System is between 5 and 8 MeV (D. Sprouse, Screening Cargo Containers to Remove a Terrorist Threat, Science & Technology Review, Lawrence Livermore National Laboratory, May 2004). Currently, there are two general approaches to produce neutrons with energy below 8 MeV: (a) using a high-energy accelerator (∞4 MeV) to accelerate deuteron on a deuteron gas target (D-D); or, (b) using low-energy accelerator to accelerate triton on a titanium target (T-T) which provides a continuum spectrum from 0 to 9 MeV. For the high-energy D-D approach, a large expensive high-energy accelerator system such as a RFQ system is required. For the low-energy T-T accelerator system, there is always an environmental safety concern for the usage of radioactive tritium.

Fast neutron analysis is generally necessary when detecting for explosives. FIG. 1 is a graph illustrating the inelastic scattering cross sections of Carbon (C), Oxygen (O), and Nitrogen (N). As shown in FIG. 1, certain energies must be reached to detect C (labeled A), O (labeled B), or N (labeled C). An energy value needed to detect C must be greater 4 MeV, to detect N it must be greater than approximately 2.5 MeV, and to detect O it must be greater than 6 MeV. Thus, the only way to produce neutrons with energies between this range is through the use of T-T since the energy produced from D-D neutron generator based on low-energy accelerator is not enough (i.e. 2.5 MeV).

Thus, a new approach of producing high-energy neutrons efficiently with low-energy accelerator is desired. Additionally, the production of neutron with energy greater than 2.5 MeV without the use of tritium would be advantageous.

### BRIEF DESCRIPTION OF THE INVENTION

This invention provides for a neutron generator comprising a boron-10 bearing target and a low-energy accelerator, wherein said low-energy accelerator emits a plurality of particles which bombard said boron-10 bearing target to cause a ¹⁰B(d,n)¹¹C reaction which in turn produces a plurality of neutrons having an energy value greater than about 2 MeV and less than about 8 MeV. In some embodiments, said plurality of particles emitted by said low-energy accelerators comprises a plurality of deuterons (D-D). In some embodiments, the generator said low-energy accelerator is a field emission ion source coupled with a single gap accelerator to accelerate said deuterons on said boron-10 bearing target.

This invention also provides for a neutron generator comprising an ion source chamber, an antenna coupled to the ion source chamber, and a boron-10 bearing target having a plurality of magnets within the target such that the generator produces a plurality of neutrons having an energy value greater than about 2 MeV and less than about 8 MeV through a ¹⁰B(d,n)¹¹C reaction.

This invention further provides for a method for detecting an explosive comprising generating a plurality of neutrons using a generator described in this specification in the direction of an object of interest, such that if said object contained an explosive then said explosive would be detected.

This invention further provides for a method for destroying a cell comprising: (a) generating a plurality of neutrons using a generator described in this specification towards a cell in proximity to a boron-10 delivery drug, (b) producing an alpha particle and a lithium-7 nucleus from said boron-10 in proximity to said cell decay, and (c) ionizing said cell with said alpha particle and/or said lithium-7 nucleus; such that said cell is destroyed. In some embodiments, the cell is a tumor cell.

### BRIEF DESCRIPTION OF THE DRAWINGS

The accompanying drawings, which are incorporated into and constitute a part of this specification, illustrate one or more embodiments and, together with the detailed description, serve to explain the principles and implementations of the invention.

In the drawings:

FIG. 1 is a graph illustrating the inelastic scattering cross sections of Carbon, Oxygen, and Nitrogen.

FIG. 2 is a graph comparing a ¹⁰B(d,n)¹¹C reaction cross section versus ²H(d,n)³He reaction cross section.

FIG. 3 is a graph illustrating the energy spectrum of neutrons emitted at θ=0° from a ¹⁰B target bombarded by 0.58 MeV deuterons.

FIG. 4 is a graph illustrating a gamma-ray spectrum during deuteron bombardment of isotropically enriched ¹⁰B target.

FIG. 5 illustrates an embodiment of a neutron generator.

### DETAILED DESCRIPTION

Before the present invention is described, it is to be understood that this invention is not limited to particular methodology or protocols described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention.

Embodiments are described herein in the context of a neutron generator. In particular, the neutron generator produces neutrons through a ¹⁰B(d,n)¹¹C reaction, and the neutrons produced by the neutron generator have an energy value greater than about 2 MeV and less than about 8 MeV. In certain embodiments, the neutrons produced by the neutron generator have an energy value greater than about 2 MeV and less than about 6 MeV. In further embodiments, the neutrons produced by the neutron generator have an energy value greater than about 4 MeV and less than about 8 MeV. Those of ordinary skill in the art will realize that the following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

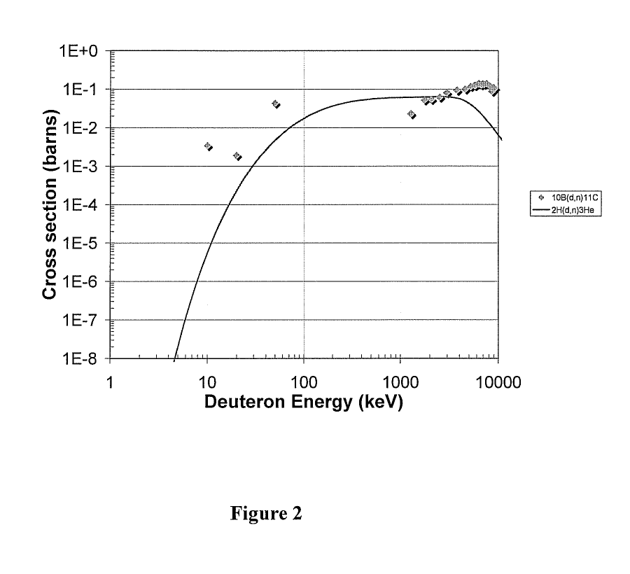

Most data obtained for a ¹⁰B(d,n)¹¹ C reaction cross section are for deuteron beam energy (greater than 500 keV). As illustrated in FIG. 2, recent measurements made by Brookhaven National Laboratory shows that the ¹⁰B(d,n)¹¹C cross section for this reaction at low deuteron energies (i.e. 10 keV, 20 keV and 50 keV) is larger than the ²H(d,n)³He cross section (M. L. Firouzbakht, D. J. Schlyer, and A. P. Wolf, Yield Measurements for the ¹¹B(p,n)¹¹C and the ¹⁰B(d,n)¹¹C Nuclear Reactions, Nuclear Medicine & Biology, Vol. 25, pp. 161-164, 1998). The reaction that occurs is:
D⁺+¹⁰B→¹¹C+n Q=6.495 MeV

The plurality of particles emitted by the low-energy accelerator have an energy value of about 50 keV to about 2 MeV. In some embodiments, the energy value of the plurality of particles is about 70 keV to about 500 keV. In certain embodiments, the energy value of the plurality of particles is about 80 keV to about 120 keV.

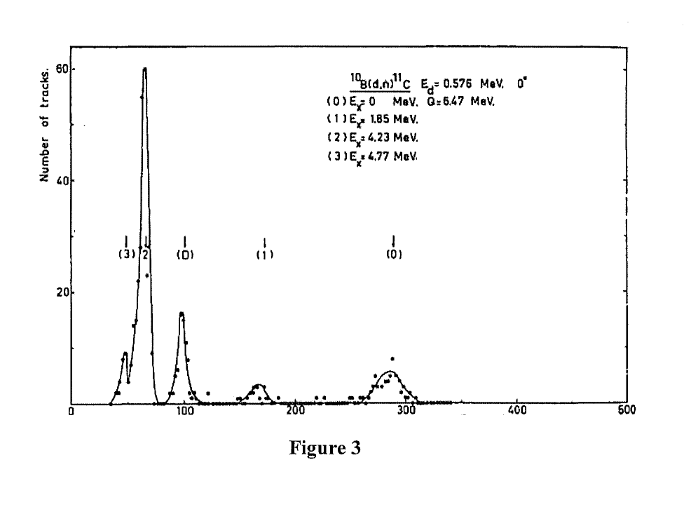

In some embodiments of the present invention, the low-energy accelerator is not a radio-frequency quardrupole (RFQ) accelerator. In further embodiments of the present invention, the particle used to bombard the boron-10 bearing target does not include any triton (T-T) or tritium containing particle. The limited available data on ¹⁰B(d,n)¹¹C cross section data suggest that a low-energy accelerator based neutron generator can be made to produce approximately 6 MeV fast neutrons without an RFQ accelerator or a tritium storage system. However, only a fraction of the end reaction products of this reaction (i.e. ¹¹C) are in ground state when the deuteron beam energy is 580 keV. FIG. 3 is a graph illustrating the energy spectrum of neutrons emitted at θ=0° from a ¹⁰B target bombarded by 0.58 MeV deuterons (C. H. Paris and P. M. Endt, Angular Distributions of Four neutron Groups from the ¹⁰B(d,n)¹¹C Reaction, Physica XX, pp. 585-591, 1954). The number of counted tracks is plotted as a function of “the corrected range” of recoil protons in μm i.e. the range of protons with the full neutron energy.

The neutrons produced from the ¹⁰B(d,n)¹¹C reaction that leads to a ground state of ¹¹C is denoted by (0) on FIG. 3 while (1), (2) and (3) denote the first, second and third excited states. There is also a peak denoted by (D) which is from the ²H(d,n)³He reaction. By integrating the number of tracks for each state and taking the neutron elastic cross section of hydrogen of the detector into account, one can estimate the branching ratio at this incident deuteron energy. The branching ratio to the ground state of ¹¹C at incident deuteron energy of 576 keV appears to be less than 50%. This branching ratio is relatively low as the 6 MeV neutrons are more favorable. Fortunately, other recent studies have suggested that the branching ratio to the ground state of ¹¹C is close to unity at lower deuteron beam energy (F. E. Cecil, R. F. Fahlsing, and R. A. Nelson, Total Cross-Section measurements for the Production of Nuclear Gamma Rays from Light Nuclei by Low-energy Deuterons, Nuclear Physics, A376, pp. 379-388, 1982). The cross sections for the ¹⁰B(d,n)¹¹C(E=4.32 MeV) reaction that leads to the second excited state at incident deuteron energy of 111, 135 and 159 keV are 0.29, 2.1 and 4.9 μb respectively.

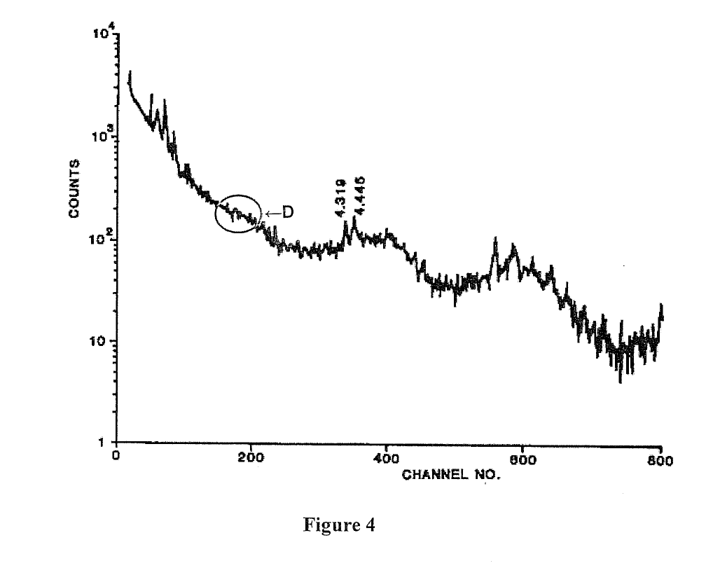

FIG. 4 is a graph illustrating a gamma-ray spectrum during deuteron bombardment of isotropically enriched ¹⁰B target. This illustrates that the ¹⁰B(d,n)¹¹C reaction that leads to the ground state at these deuteron energy should be in the milli-bam (mb) range. It also shows that a large branching ratio of this reaction may not lead to the existence of the first excited state because there is no 2 MeV peak in the gamma-ray spectrum measured during deuteron bombardment of a ¹⁰B target at these energies. FIG. 4 would have peaks at 2 MeV (marked as D) and 4.8 MeV if the branching ratios for the first and third excited states were larger than that of the second excited state.

In some embodiments of the present invention, the boron-10 bearing target comprises lanthanide hexaboride (LaB₆). From the data, it is believed that the branching ratio to ground state for this reaction, at about 100 keV deuteron energy, is very close to unity. By bombarding a boron-10 rich target, such as lanthanide hexaboride (LaB₆), with low-energy (about 100 keV) deuterons, fast neutrons of about 6 MeV may be produced.

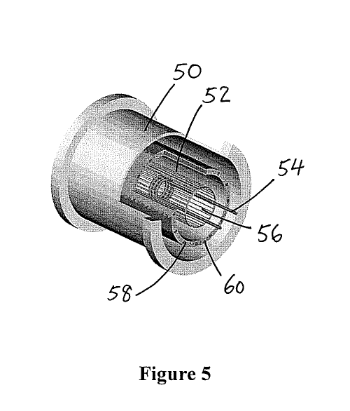

The large cross-section at low incident deuteron energies of this reaction allows neutron production using low-energy high beam current accelerator designs. FIG. 5 illustrates an embodiment of a coaxial low-energy accelerator based neutron generator. The generator may have a vacuum chamber 50, an extraction grid 52, a radio-frequency (RF) antenna 54, an ion source chamber 56, and magnets 58 positioned within a target 60. The generator illustrated is only one embodiment of a generator and those of ordinary skill in the art will realize that the generator may be built with various designs. The generator illustrated in FIG. 5 is a coaxial type neutron generator that may also be used for D-D neutron production. Multiple ion beamlets may be extracted radially from the cylindrical surface of the ion source chamber 56. These beamlets will spread out and impinge on the inner surface of a surrounded cylindrical target 60.

Large target surface areas in coaxial designs allow for very high beam current operation with minimal heat load on the target. The generator is capable of producing 10¹¹ D-D neutrons per second (n/s) and may even be used to provide boron neutron capture therapy (BNCT) to patients with liver tumor. The neutron yield is a record high number for D-D neutron generators and may be redesigned to produce 6 MeV neutrons by merely using a ¹⁰B bearing target, which can be lanthanum hexaboride (LaB₆). LaB₆, which is a compound often used to make cathodes for electron emission, is a rigid ceramic with high electrical conductivity and chemically stable.

The invention further provides for the use of the neutron generator in the context of BNCT protocols. BNCT is a binary system designed to deliver ionizing radiation to tumor cells by neutron irradiation of tumor-localized ¹⁰B atoms. In the present method for destroying a cell, in some embodiments the cell is a tumor cell. In certain embodiments, the tumor cell is part of a solid tumor. In certain embodiments, the tumor cell or solid tumor is in a subject, such as a human patient in need of removal of said tumor cell or solid tumor.

BNCT is based on the nuclear reaction which occurs when a stable isotope, isotopically enriched ¹⁰B, is irradiated with thermal neutrons to produce an alpha particle and a ⁷Li nucleus. These particles have a path length of about one cell diameter, resulting in high linear energy transfer. Just a few of the short-range 1.7 MeV alpha particles produced in this nuclear reaction are sufficient to target the cell nucleus and destroy it. Success with BNCT of cancer requires methods for localizing a high concentration of ¹⁰B at tumor sites, while leaving non-target organs essentially boron-free. Compositions and methods for treating tumors in subjects using BNCT are well known to those of ordinary skill in the art, and are described in, e.g., U.S. Pat. Nos. 4,516,535; 6,228,362; 6,685,619; and 7,138,103, which are incorporated by reference in their entireties, and can easily be modified for the purposes of the present invention.

In some embodiments, the neutron generator produces fast neutrons with an energy of about 6 MeV with a 100 keV electrostatic single gap accelerator.

In some embodiment, the neutron yield of the neutron generator is equal to or more than about 5×10¹¹ n/s. In other embodiments, the neutron yield is less than about 5×10¹¹ n/s.

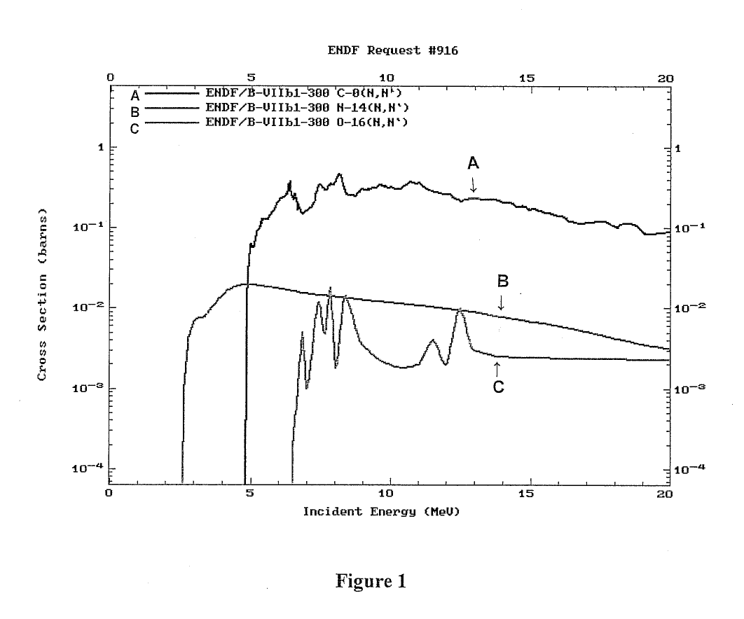

The neutron generator can also be used for the detection of explosives since its neutron energy is above the threshold of the inelastic scattering and charged particle production cross sections of elements in chemical explosives as shown in FIG. 1. This neutron generator can also be used in any neutron based active interrogation systems and is particularly advantageous for screening of any object containing, suspected to contain or can contain nuclear materials, explosives, and/or drugs. The neutron generator can locate and identify such nuclear materials, explosives, and drugs. In some embodiments, said nuclear materials and explosives include SNM, such as weapons grade uranium or weapons grade plutonium.

This neutron generator can also be applied with fast neutron analysis, fast neutron transmission spectroscopy and any other techniques requiring fast neutrons to locate and identify nuclear materials, explosives, and/or drugs.

This neutron generator can be used to inspect nuclear waste packages, monitor nuclear material inventory in a reprocessing plant or enrichment plant, or perform non-destructive assay of nuclear fuel elements.

Furthermore, the ¹⁰B(d,n)¹¹C neutron source may further produce an annihilation photon from the positron decay of ¹¹C. After approximately an hour of operation, the target (ie. boron) will become a strong 511 keV photon source with a photon yield approximately twice as much as a 6 MeV neutron yield. Thus, this allows for a combined neutron-photon source that requires only one single low-energy accelerator. The photon can be used to obtain radiographic picture of the object being inspected while the neutron can provide elemental information of the inspected object at the same time.

Since the use of tritium is avoided, the accelerator that may be used will be cheaper, more compact, and environmentally safer to operate. And since there is no major target heating problem that limits the beam current in the D-D neutron generator, this may also be applied to numerous medical application such as BCNT as described above.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A neutron generator comprising a boron-10 bearing target and a low-energy accelerator, wherein said low-energy accelerator emits a plurality of particles which bombard said boron-10 bearing target to cause a ¹⁰B(d,n)¹¹C reaction which in turn produces a plurality of neutrons having an energy value greater than about 2 MeV and less than about 8 MeV.

2. The neutron generator of claim 1, wherein said particles emitted by said low-energy accelerators comprises a plurality of deuterons (D-D).

3. The neutron generator of claim 1, wherein said low-energy accelerator is a field emission ion source coupled with a single gap accelerator to accelerate said plurality of deuterons on said boron-10 bearing target.

4. The neutron generator of claim 1 further comprising an ion source chamber, an antenna coupled to the ion source chamber, and said boron-10 bearing target having a plurality of magnets within the target such that the generator produces said plurality of neutrons having an energy value greater than about 2 MeV and less than about 8 MeV.

5. The neutron generator of claim 1, wherein boron-10 bearing target comprises lanthanide hexaboride (LaB₆).

6. The neutron generator of claim 1, wherein the neutrons produced by the neutron generator have an energy value greater than about 2 MeV and less than about 6 MeV.

7. The neutron generator of claim 1, wherein the neutrons produced by the neutron generator have an energy value greater than about 4 MeV and less than about 8 MeV.

8. The neutron generator of claim 1, wherein said low-energy accelerator is not a radio-frequency quardrupole (RFQ) accelerator.

9. The neutron generator of claim 1, wherein said particle used to bombard the boron-10 bearing target does not include any triton (T-T) or tritium containing particle.

10. A method for detecting a nuclear material, explosive or drug comprising: generating a plurality of neutrons using a neutron generator of claim 1 the direction of an object of interest, such that if said object contained a nuclear material, explosive or drug then said nuclear material, explosive or drug would be detected.

11. A method for destroying a cell comprising: (a) generating a plurality of neutrons using a neutron generator of claim 1 towards a cell in proximity to a boron-10, (b) producing an alpha particle and a lithium-7 nucleus from said boron-10 in proximity to said cell decay, and (c) ionizing said cell with said alpha particle and/or said lithium-7 nucleus; such that said cell is destroyed.

12. The method of claim 11, wherein said cell is a tumor cell.
